(19) United States
(12) Patent Application Publication
(10) Pub. No.: US 2024/0267768 A1
(43) Pub. Date: Aug. 8, 2024

(54) RELAXATION COMPENSATION FOR IMPROVED SYSTEM PERFORMANCE

(71) Applicant: Nokia Technologies Oy, Espoo (FI)

(72) Inventors: Lars DALSGAARD, Oulu (FI); Jorma Johannes KAIKKONEN, Oulu (FI); Lei DU, Beijing (FI)

(21) Appl. No.: 18/564,830

(22) PCT Filed: Jun. 2, 2021
(86) PCT No.: PCT/CN2021/097953

§ 371 Date: Nov. 28, 2023

(51) Int. Cl. H04W 24/08; H04W 8/22; H04W 24/10

(52) U.S. Cl. CPC H04W 24/08; H04W 8/22; H04W 24/10

(57) ABSTRACT

Embodiments of the present disclosure relate to devices, methods, apparatuses and computer readable storage media of relaxation compensation for improved system performance. The method comprises determining one or more parameters for compensating a delay associated with at least one evaluation of a measurement, the measurement comprising at least one of a RLM or a BFD, and in accordance with a determination that the first device is to be switched from a relaxed measurement mode to a non-relaxed measurement mode, performing the measurement compensation in the non-relaxed measurement mode based on the one or more parameters. In this way, the negative system impact from the relaxed UE RLM/BFD measurements can be removed and meanwhile the power saving of the UE can also be achieved.

### FIELD

Embodiments of the present disclosure generally relate to the field of telecommunication and in particular to devices, methods, apparatuses and computer readable storage media of relaxation compensation for improved system performance.

### BACKGROUND

It has been discussed that the power saving of the User Equipment (UE) can be reached by relaxation some measurements performed at the UE. For example, such measurements can be Radio link Monitoring (RLM) or Beam Failure Detection (BFD).

Particularly for the UE having low mobility with short DRX periodicity/cycle, the feasibility and performance impact of relaxing UE measurements is the key point for the discussion.

### SUMMARY

In general, example embodiments of the present disclosure provide a solution of relaxation compensation for improved system performance.

In a first aspect, there is provided a first device. The first device comprises at least one processor; and at least one memory including computer program codes; the at least one memory and the computer program codes are configured to, with the at least one processor, cause the first device at least to determine one or more parameters for compensating a delay associated with at least one evaluation of a measurement, the measurement comprising at least one of a RLM or a BFD, and in accordance with a determination that the first device is to be switched from a relaxed measurement mode to a non-relaxed measurement mode, perform the measurement compensation in the non-relaxed measurement mode based on the one or more parameters.

In a second aspect, there is provided a method. The method comprises determining one or more parameters for compensating a delay associated with at least one evaluation of a measurement, the measurement comprising at least one of a RLM or a BFD, and in accordance with a determination that the first device is to be switched from a relaxed measurement mode to a non-relaxed measurement mode, performing the measurement compensation in the non-relaxed measurement mode based on the one or more parameters.

In a third aspect, there is provided an apparatus comprising means for determining one or more parameters for compensating a delay associated with at least one evaluation of a measurement, the measurement comprising at least one of a RLM or a BFD, and means for in accordance with a determination that the first device is to be switched from a relaxed measurement mode to a non-relaxed measurement mode, performing the measurement compensation in the non-relaxed measurement mode based on the one or more parameters.

In a fourth aspect, there is provided a computer readable medium having a computer program stored thereon which, when executed by at least one processor of a device, causes the device to carry out the method according to the second aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a comparison between the relaxed measurements and the non-relaxed measurements according to some example embodiments of the present disclosure;

FIG. 3 shows an example of relaxation compensation according to some example embodiments of the present disclosure;

FIG. 4 shows a flowchart of an example method of relaxation compensation according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G. 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUS (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

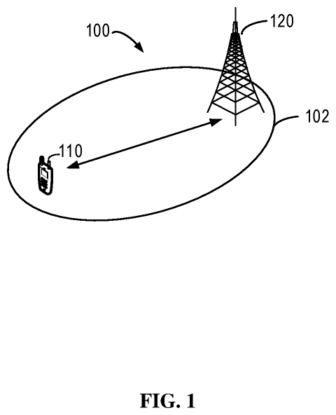

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise a network device 120 (hereinafter may also be referred to as a gNB 120 or a second device 120). The network device 120 can manage a cell 102. The terminal device 110 and the network device 120 can communicate with each other in the coverage of the cell 102.

It is to be understood that the number of network devices and terminal devices shown in FIG. 1 is given for the purpose of illustration without suggesting any limitations. The communication network 100 may include any suitable number of network devices and terminal devices.

As mentioned above, the feasibility and performance impact of relaxing UE measurements such as e.g. RLM and BFD, for the UE having low mobility with short DRX periodicity/cycle is to be discussed.

In general, whether relaxed measurements e.g. including RLM/BFD related measurements can be implemented may depend on multiple aspects such as experienced signal quality at UE, the serving cell quality and the mobility state of the UE. For example, if the cell conditions are good enough or the UE has low mobility, the UE may be allowed to relax the related measurements, such as RLM and BFD. Enabling and allowing measurement relaxation, like e.g. RLM and/or BFD, at the UE could also be based on other conditions such as e.g. the perceived signal quality at the UE receiver.

Correspondingly, for example, if the cell condition is getting worse or the mobility of the UE increases, the UE can resume the normal measurement, i.e., the non-relaxed measurement.

It has been proposed that a relaxation factor K can be used for determining an evaluation period for the relaxed measurement. For example, for the UE with a DRX cycle less than 80 ms, the evaluation period TE can be represented by Max(200, cell(15*P)*Max(T_{DRX}, T_{SSB})+(K−1)*Max(T_{DRX}, T_{SSB}).

In conventional way, in a case where the UE performs a RLM measurement, the UE shall evaluate, using the averaged results of samples taken during the evaluation period, the link quality against internal BLER mapping. For example, if the UE determines that BLER level corresponding to the estimated channel quality is worse than a set threshold (Qₒᵤₜ) which can be that it is higher than 10%, the UE will send an indication of out-of-sync indication to upper layers of the UE. The threshold Qₒᵤₜ can be defined as the level at which the downlink radio link cannot be reliably received and shall correspond to the out-of-sync block error rate (BLERₒᵤₜ).

It has been discussed that the UE while performing relaxed RLM upon detecting one or more of Qₒᵤₜ indications or upon triggering T310 or upon observed link quality degradation or mobility state change reverts to the normal RLM operation. Similar operation may also be performed for BFD.

For the UE in a relaxed measurement mode, it is also proposed that the initial Out-of-sync indication based on the relaxed measurement shall not be used as indication to upper layers. Instead an initial out-of-sync based on the relaxed measurements would trigger UE to perform non-relaxed RLM measurement and only if in a case where the RLM evaluation is based on the non-relaxed measurements, the out-of-sync would be sent to upper layers. The out-of-sync could be based on existing Qₒᵤₜ threshold or modified Qₒᵤₜ threshold.

Such proposals may delay the RLM procedure and the final RLF trigger on the UE side. In one example case, at least one additional evaluation period delay will be introduced. Hence, the RLF triggering will be delayed which has negative impact on the UE, the user experience and the network performance.

Therefore, the present disclosure provides solutions of relaxation compensation. In this solution, the UE may determine one or more parameters for compensating a delay associated with at least one evaluation of a measurement. If the UE determines that the UE is to switch or be switched from a relaxed measurement mode to a non-relaxed measurement mode, the UE may perform the measurement and/or measurement compensation in the non-relaxed measurement mode based on the one or more parameters or compensated parameters.

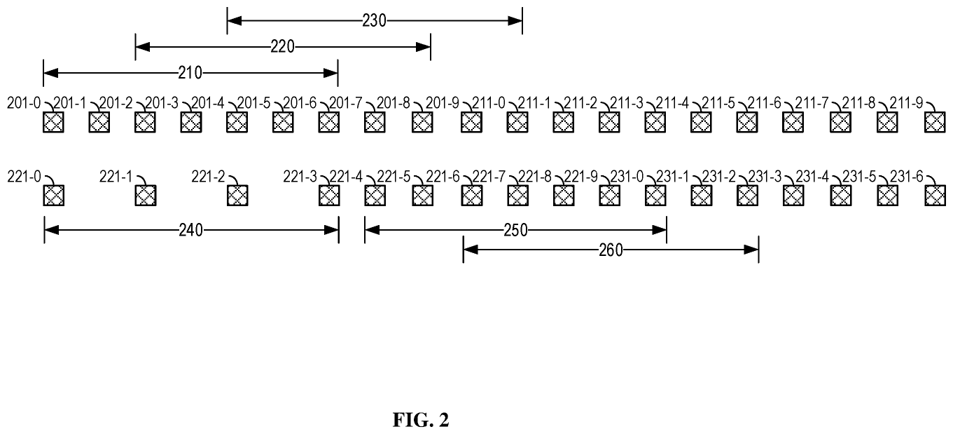

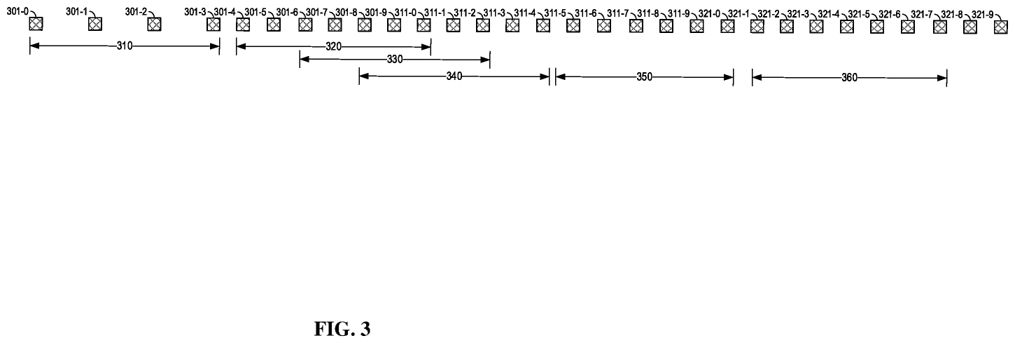

Principle and implementations of the present disclosure will be described in detail below with reference to FIGS. 2 and 3. FIG. 2 shows a comparison between the relaxed measurements and the non-relaxed measurements according to some example embodiments of the present disclosure. For the purpose of discussion, FIG. 2 will be described with reference to FIG. 1.

The UE 110 may perform some measurements for radio resource management such as RLM. In a non-relaxed measurement mode of RLM, the UE 110 may evaluate the link quality based on a plurality of samples periodically.

It is to be understood that hereinafter the RLM is to be used as example for illustrating the principle. The solution herein described may also be used for other measurement, for example, a link recovery procedure and BFD.

The RLM is designed and used as a ‘safe guard’ and error protection mechanism in the NR and other wireless systems to avoid UE falling into an out of service situation and not being able to receive or transmit for a long time. Increasing the time when UE is out of service before triggering Radio Link Failure (RLF) to initiate a radio link recovery procedure has significant negative impact on the user experience, the UE and overall system performance.

For example, as shown in FIG. 2, the UE may evaluate the link quality in a first evaluation period 210 of the RLM measurement based on the samples 201-0 to 201-6. The UE 110 may map the results of the estimated link quality against the internal BLER estimate. If the UE 110 determines that the estimated link quality may lead to a BLER level higher than 10%, for example, an out-of-sync (OoS) indication can be sent from a lower layer of the UE 110 to a higher layer of the UE 110.

Such evaluations can also be performed by the UE 110 based on the samples 201-2 to 201-8 in a second evaluation period 220 of the RLM measurement and based on the samples 201-4 to 211-0 in a third evaluation period 230 of the RLM measurement. If the UE 110 determines that the estimated link quality may lead to a BLER level higher than 10%, for example, the OoS indication can be sent from a lower layer of the UE 110 to a higher layer of the UE 110 after each evaluation period.

For each time the link quality is worse than threshold Qₒᵤₜ and an OoS indication is delivered from lower layer to upper layer the UE will increase a counter N310. If N310 reaches a configured maximum number, the UE will start timer T310. The UE may continue to measure and evaluate the channel quality and estimated BLER level while T310 is running. If the channel conditions are not improved within T310, the UE may declare RLF when the T310 expires.

Comparing with the non-relaxed measurement mode, the UE 110 may perform the measurement in a relaxed measurement mode by evaluating the link quality e.g., with fewer samples or by increasing the evaluation time (while using same number of samples) or a combination thereof. It is to be understood that when the RLM measurement is performed in the relaxed measurement mode, there is a period during which the UE is evaluating RLM based on a reduced number of samples or extended evaluation time or a combination thereof. Therefore, such evaluations may be inaccurate compared with the evaluations performed based on the non-relaxed number of samples or evaluation period. In the following we explain the method by applying less samples while keeping the evaluation period unchanged. However, same principle can be applied if keeping the number of samples unchanged and increasing the evaluation period.

As shown in FIG. 2, in a relaxed measurement mode of the RLM measurement, the UE may evaluate the link quality in a first evaluation period 240 of the RLM measurement based on the samples 221-0 to 221-3. It is to be understood that the evaluation period 240 may not be same as the first evaluation period 210. If the UE 110 determines that the estimated link quality may lead to a BLER level higher than a threshold level, for example 10%, the UE 110 may determine that the subsequent measurements may be performed in the non-relaxed measurement mode and the OoS indication may not to be sent from a lower layer of the UE 110 to a higher layer of the UE 110 after the evaluation period 240.

Then the UE 110 may further evaluate the link quality based on the samples 221-4 to 231-0 in a second evaluation period 250 of the RLM measurement in the non-relaxed measurement mode. Similarly, the UE 110 may further evaluate the link quality based on the samples 221-6 to 231-2 in a third evaluation period 260 of the RLM measurement in the non-relaxed measurement mode. If the UE 110 determines that the estimated link quality may lead to a BLER level higher than 10%, for example, the OoS indication can be sent from a lower layer of the UE 110 to a higher layer of the UE 110 after each evaluation period 250 and 260.

As shown, comparing with the non-relaxed measurement mode, the trigger of the RLF may be delayed in the relaxed measurement mode at least by one evaluation period. Thus, the relaxation compensation can be performed by the UE 110.

The UE 110 may determine one or more parameters for compensating a delay associated with at least one evaluation of a measurement. The T_{evaluation_period} can be represented as below:

$${T}_{Evaluate \_ out \_ SSB} = Max ( 200 , Ceil ( 15 * P * N ) * Max ( {T}_{DRX} , {T}_{SSB} ) ) \qquad ( 1 )$$

where N is only applied in FR2 and not in FR1.

In some example embodiments, the UE 110 may determine the one or more parameters for compensating the delay by itself.

For example, the UE 110 may determine a first time interval within which the OoS indication is sent from a lower layer of the UE 110 to an upper layer of the UE 110. Hereinafter the first time interval may be referred to as T_{indication_interval} (Tᵢ). When the DRX is used, the first time interval Tᵢ can be represented as below (when DRX cycle length is e.g. 320 ms or less):

$${T}_{i} = Max ( 10 ms , 1.5 \times DRX\_cycle \_length , 1.5 \times {T}_{{RLM}^{-} RS , M} ) ) \qquad ( 2 )$$

The UE 110 may further determine a second time interval when DRX is not used or if the timer T310 is running, of the indication interval. The second time interval can be considered the same as if DRX is not used, and the time interval from the timer starts to the timer expires. Hereinafter the second time interval may be referred to as T_{Indication_interval} (T_{I}). The second time interval T_{I} can be represented as below:

$${T}_{I} = max ( 10 ms , {T}_{{RLM}^{-} RS , M} ) \qquad ( 3 )$$

The UE 110 may determine the one or more parameters for compensating the delay based on the T_{evaluation_period}, the first time interval T_{indication_interval} and the second time interval T Indication_interval.

For example, in a case where the reference signal used for evaluation period is 20 ms and the DRX is 40 ms, the additional delay is 600 ms. For compensating the delay, the UE 110 may consider reducing the threshold number of the counter N310 or reducing the duration of the timer T310.

Therefore, the one or more parameters, which may be determined by the UE 110 or configurable by network or directly specified, may comprise a compensation value for a threshold value of a counter and/or duration of a timer. As an example, assuming that the original threshold number of the counter N310 is 10 and the duration of the timer T310 is 1000 ms, in one example the compensated threshold number of the counter N310 can be represented as N310′=0,5*N310 and the compensated timer T310′ can be represented as T310−(N310′*T_{indication_interval}). In one example the UE may determine how to compensate for the delay. In another example the network configures the UE how to compensate for the delay. In yet another example the specification determines delay compensation.

It is also possible that the UE 110 determines the one or more parameters for compensating the delay based on the relaxation factor K configured for the relaxed measurement. In this case, the compensation value for a threshold value of a counter and/or duration of a timer can be determined depending on the configured relaxation factor.

For example, the UE may be configured with relaxation factor K=4, and for example the counter is configured to value. When the relaxation is applied, the UE 110 may adjust the applied counter value by (k-1) steps, so that the counter value may be smaller than the value used when no relaxation is applied.

In some example embodiments, the one or parameters for compensating the delay determined by the UE 110 may be configured and transmitted from the UE 110 to gNB 120. For example, the UE 110 may report the capability for delay compensation e.g. when the UE 110 exits the relaxed measurement mode.

In some example embodiments, the one or parameters for compensating the delay can also be configured by the gNB 120. For example, the gNB 120 may transmit the configuration for compensating the delay to the UE 110 and the UE 110 may obtain the one or parameters from the configuration.

After determining the one or more parameters for compensating the delay, the UE 110 may perform the measurement based on the one or more parameters. For example, the UE 110 may use the compensated threshold value of the counter and/or the compensated timer to determine the trigger of the RLF.

It is to be understood that the above mentioned solution for compensating the delay can also be applied for the BFD. For example, the UE 110 may use the compensated threshold value of the counter and/or the compensated timer to determine the trigger of the beam failure.

FIG. 3 shows an example of relaxation compensation according to some example embodiments of the present disclosure. The actual measurement sampling and evaluation period are illustrative and should not be seen as limiting the principles of the method.

As shown in FIG. 3, the UE may evaluate the link quality based on the samples 301-0 to 301-3 in a first evaluation period 310 of the RLM measurement in a relaxed measurement mode. If the UE 110 determines that the estimated link quality may lead to a BLER level higher than a threshold level, the UE 110 may determine that the subsequent measurement may be performed in the non-relaxed measurement mode.

After determining the one or more parameters for compensating the delay, the UE 110 may perform the subsequent measurement based on the one or more parameters, i.e., with a compensated threshold value of the counter and/or a compensated duration of the timer.

Then the UE 110 may further evaluate the link quality based on the samples 301-4 to 301-9 and 311-0 in a second evaluation period 320 of the RLM measurement in the non-relaxed measurement mode. Similarly, the UE 110 may further evaluate the link quality based on the samples 301-6 to 301-9 and 311-0 to 311-3 in a third evaluation period 330 of the RLM measurement in the non-relaxed measurement mode and evaluate the link quality based on the samples 301-8 to 301-9 and 311-0 to 311-5 in a fourth evaluation period 340 of the RLM measurement in the non-relaxed measurement mode. If the UE 110 determines that the estimated link quality in each evaluation period leads to the BLER level higher than a threshold level, the OoS indication is to be sent from a lower layer of the UE 110 to a higher layer of the UE 110 after each evaluation period.

If the counter reaches the compensated threshold value after the fourth evaluation period 340, the timer will be started. For example, the timer will run within the time interval 350. If the UE 110 determines that the link quality is not improved within the time interval 350, the UE 110 may trigger the RLF. The above-mentioned process can also be suitable for the BFD.

With the one or more parameters for compensating the delay, the UE may compensate the delay caused by at least one evaluation when the measurement is switched from the relaxed measurement mode to the non-relaxed measurement mode. As shown in FIG. 3, without the delay compensation, the trigger of the RLF or beam failure can be triggered, for example, only after the time interval 360.

In this way, the negative system impact from the relaxed UE RLM/BFD measurements can be removed and meanwhile the power saving of the UE can also be achieved.

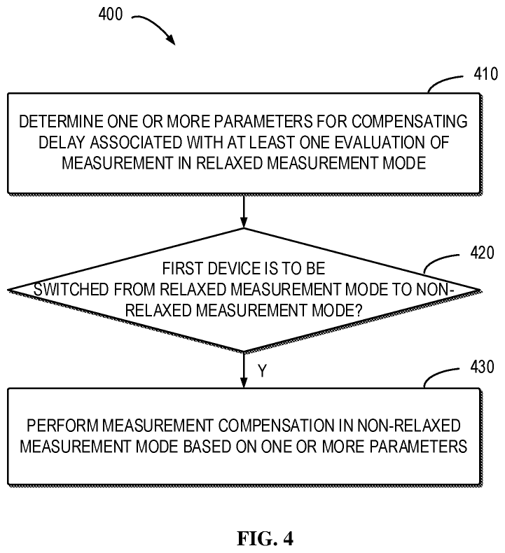

FIG. 4 shows a flowchart of an example method 400 of relaxation compensation according to some example embodiments of the present disclosure. The method 400 can be implemented at the first device 110 as shown in FIG. 1. For the purpose of discussion, the method 400 will be described with reference to FIG. 1.

At 410, the first device determines one or more parameters for compensating a delay associated with at least one evaluation of a measurement, the measurement comprising at least one of the RLM and the BFD.

In some example embodiments, the first device may determine a first time interval within which an indication of out-of-sync is transmitted from a lower layer of the first device to an upper layer of the first device and a second time interval of a timer associated with the measurement. The first device may determine the one or more parameters based on the at least one evaluation, the first and the second time intervals.

In some example embodiments, the first device may receive a configuration for compensating the delay from a second device and determine the one or more parameters from the configuration.

In some example embodiments, the one or more parameters may comprise a first compensation value for a threshold value of a counter associated with the measurement; or a second compensation value for duration of a timer associated with the measurement.

In some example embodiments, the first device may transmit, to a second device, an indication of a capability for compensating the delay.

At 420, if the first device determines that the first device is to be switched from a relaxed measurement mode to a non-relaxed measurement mode, the first device performs the measurement compensation in the non-relaxed measurement mode based on the one or more parameters.

In some example embodiments, the first device may determine a reference time interval for triggering the radio link failure during the RLM by at least partially compensating the delay based on the one or more parameters. The first device may perform the RLM based on the reference time interval.

In some example embodiments, the first device may determine a reference time interval for triggering the beam failure during the BFD by at least partially compensating the delay based on the one or more parameters and perform the BFD based on the reference time interval.

In some example embodiments, the first device comprises a terminal device and the second device comprises a network device.

In some example embodiments, an apparatus capable of performing the method 400 (for example, implemented at the UE 110) may comprise means for performing the respective steps of the method 400. The means may be implemented in any suitable form. For example, the means may be implemented in a circuitry or software module.

In some example embodiments, the apparatus comprises means for determining one or more parameters for compensating a delay associated with at least one evaluation of a measurement, the measurement comprising at least one of a RLM or a BFD, and means for in accordance with a determination that the first device is to be switched from a relaxed measurement mode to a non-relaxed measurement mode, performing the measurement compensation in the non-relaxed measurement mode based on the one or more parameters.

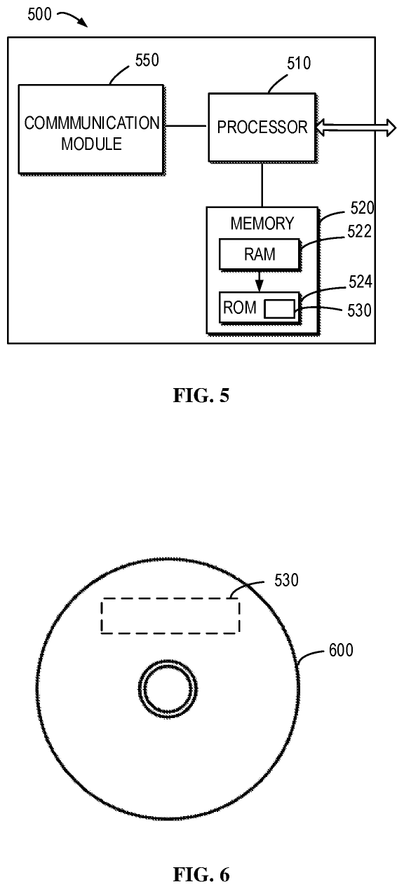

FIG. 5 is a simplified block diagram of a device 500 that is suitable for implementing embodiments of the present disclosure. The device 500 may be provided to implement the communication device, for example the UE 110 as shown in FIG. 1. As shown, the device 500 includes one or more processors 510, one or more memories 540 coupled to the processor 510, and one or more transmitters and/or receivers (TX/RX) 540 coupled to the processor 510.

The TX/RX 540 is for bidirectional communications. The TX/RX 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 520. The processor 510 may perform any suitable actions and processing by loading the program 530 into the RAM 520.

The embodiments of the present disclosure may be implemented by means of the program 530 so that the device 500 may perform any process of the disclosure as discussed with reference to FIGS. 2 to 4. The embodiments of the present disclosure may also be implemented by hardware or by a combination of software and hardware.

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A first device comprising:
at least one processor; and
at least one memory including computer program codes;
the at least one memory and the computer program codes are configured to, with the at least one processor, cause the first device at least to:
determine one or more parameters for compensating a delay associated with at least one evaluation of a measurement, the measurement comprising at least one of the following:
a radio link monitoring, or
a beam failure detection, and
in accordance with a determination that the first device is to be switched from a relaxed measurement mode to a non-relaxed measurement mode, perform the measurement compensation in the non-relaxed measurement mode based on the one or more parameters.

22. The first device of claim 21, wherein the first device is caused to determine the one or more parameters by:
determining a first time interval within which an indication of out-of-sync is transmitted from a lower layer of the first device to an upper layer of the first device;
determining a second time interval of a timer associated with the measurement; and
determining the one or more parameters based on the at least one evaluation, the first and the second time intervals.

23. The first device of claim 21, wherein the first device is caused to determine the one or more parameters by:
receiving a configuration for compensating the delay from a second device; and
determining the one or more parameters from the configuration.

24. The first device of claim 23, wherein the second device comprises a network device.

25. The first device of claim 21, wherein the one or more parameters comprising:
a first compensation value for a threshold value of a counter associated with the measurement; or
a second compensation value for duration of a timer associated with the measurement.

26. The first device of claim 21, wherein the first device is further caused to:
transmit, to a second device, an indication of a capability for compensating the delay.

27. The first device of claim 21, wherein the measurement comprises the radio link monitoring, and wherein the first device is caused to perform the measurement by:
determining a reference time interval for triggering the radio link failure during the radio link monitoring by at least partially compensating the delay based on the one or more parameters; and
performing the radio link monitoring based on the reference time interval.

28. The first device of claim 21, wherein the measurement is beam failure detection, and wherein the first device is caused to perform the measurement by:
determining a reference time interval for triggering the beam failure during the beam failure detection by at least partially compensating the delay based on the one or more parameters; and
performing the beam failure detection based on the reference time interval.

29. The first device of claim 21, wherein the first device comprises a terminal device.

30. A method comprising:
determining one or more parameters for compensating a delay associated with at least one evaluation of a measurement, the measurement comprising at least one of the following:
a radio link monitoring, or
a beam failure detection, and
in accordance with a determination that the first device is to be switched from a relaxed measurement mode to a non-relaxed measurement mode, performing the measurement in the non-relaxed measurement mode based on the one or more parameters.

31. The method of claim 30, wherein determining the one or more parameters comprises:
determining a first time interval within which an indication of out-of-sync is transmitted from a lower layer of the first device to an upper layer of the first device;
determining a second time interval of a timer associated with the measurement; and
determining the one or more parameters based on the at least one evaluation, the first and the second time intervals.

32. The method of claim 30, wherein determining the one or more parameters comprises:
receiving a configuration for compensating the delay from a second device; and
determining the one or more parameters from the configuration.

33. The method of claim 32, wherein the second device comprises a network device.

34. The method of claim 30, wherein the one or more parameters comprising:
a first compensation value for a threshold value of a counter associated with the measurement; or
a second compensation value for duration of a timer associated with the measurement.

35. The method of claim 30, further comprising:
transmitting, to a second device, an indication of a capability for compensating the delay.

36. The method of claim 30, wherein the measurement comprises the radio link monitoring, and wherein performing the measurement comprises:
determining a reference time interval for triggering the radio link failure during the radio link monitoring by at least partially compensating the delay based on the one or more parameters; and
performing the radio link monitoring based on the reference time interval.

37. The method of claim 30, wherein the measurement comprises the beam failure detection, and wherein performing the measurement comprises:
determining a reference time interval for triggering the beam failure during the beam failure detection by at least partially compensating the delay based on the one or more parameters; and
performing the beam failure detection based on the reference time interval.

38. The method of claim 30, wherein the first device comprises a terminal device.

39. A non-transitory computer readable medium comprising program instructions that, when executed by an apparatus, cause an apparatus to perform at least the following:
determining one or more parameters for compensating a delay associated with at least one evaluation of a measurement, the measurement comprising at least one of the following:
a radio link monitoring, or
a beam failure detection, and
in accordance with a determination that the first device is to be switched from a relaxed measurement mode to a non-relaxed measurement mode, performing the measurement in the non-relaxed measurement mode based on the one or more parameters.
